(19) United States
(12) Patent Application Publication
(10) Pub. No.: US 2023/0268512 A1
(43) Pub. Date: Aug. 24, 2023

(54) POSITIVE ELECTRODE FOR RECHARGEABLE LITHIUM BATTERY AND RECHARGEABLE LITHIUM BATTERY INCLUDING THE SAME

(71) Applicant: Samsung SDI Co., Ltd., Yongin-si, Gyeonggi-do (KR)

(72) Inventors: Jin-Su HA, Yongin-si (KR); Sungjin AHN, Yongin-si (KR); San MOON, Yongin-si (KR); Seongho JEON, Yongin-si (KR); Minho CHO, Yongin-si (KR)

(21) Appl. No.: 18/003,952

(22) PCT Filed: Oct. 12, 2021
(86) PCT No.: PCT/KR2021/014002

§ 371 Date: Dec. 30, 2022

(30) Foreign Application Priority Data
Oct. 13, 2020 (KR) 10-2020-0132162

(51) Int. Cl. H01M 4/62; H01M 4/485; H01M 10/052; H01M 4/525; H01M 4/38; H01M 4/583

(52) U.S. Cl. CPC H01M 4/622; H01M 4/485; H01M 10/052; H01M 4/525; H01M 4/382; H01M 4/583; H01M 4/386; H01M 2004/028

(57) ABSTRACT

Provided are a positive electrode for a rechargeable lithium battery and a rechargeable lithium battery including the same, the positive electrode including a positive electrode active material, a conductive material, and a binder, wherein the positive electrode includes a polyimide-based polymer having a carboxyl group. The positive electrode has excellent lithium ion conductivity as well as prevents a side reaction of a positive electrode active material with an electrolyte by including a polyimide-based polymer having a carboxyl group in a positive electrode, wherein the polyimide-based polymer having high heat resistance and high stability is not phase-decomposed in the positive electrode to form a complex compound but protects the surface of the positive electrode active material.

### CROSS-REFERENCE TO RELATED APPLICATIONS

This application is a U.S. National Phase Patent Application of International Application Number PCT/KR2021/014002, filed on Oct. 12, 2021, which claims priority to Korean Patent Application Number 10-2020-0132162, filed on Oct. 13, 2020, the entire content of each of which is incorporated herein by reference.

### TECHNICAL FIELD

A positive electrode for a rechargeable lithium battery and a rechargeable lithium battery including the same are disclosed.

### BACKGROUND ART

Recently, as electronic devices using batteries such as portable phones, laptop computers, electric vehicles, and the like have been rapidly spread, a demand for rechargeable batteries having relatively high-capacity as well as being small and light is rapidly increasing. In particular, the rechargeable lithium batteries are light and have a high energy density and thus draw attentions as a driving power source for portable devices. Accordingly, research and development efforts to improve performance of the rechargeable lithium batteries are being actively conducted.

The rechargeable lithium batteries, in a state of charging an organic electrolyte or a polymer electrolyte between positive and negative electrodes made of active materials capable of intercalating and deintercalating lithium ions, generate electrical energy through oxidation and reduction when the lithium ions are intercalated/deintercalated from the positive and negative electrodes.

Lithium cobalt oxide (LiCoO₂), lithium nickel oxide (LiNiO₂), lithium manganese oxide (LiMnO₂ or LiMn₂O₄), a lithium iron phosphate compound (LiFePO₄) have been used as a positive electrode active material of a rechargeable lithium battery. In addition, as a method of improving low thermal stability as well as maintaining excellent reversible capacity of LiNiO₂, lithium composite metal oxide in which a portion of nickel (Ni) is substituted with cobalt (Co) or manganese (Mn)/aluminum (Al) (hereinafter, abbreviated as ‘NCM-based lithium composite transition metal oxide’ or ‘NCA-based lithium composite transition metal oxide’) has been developed. However, the conventionally developed NCM-based/NCA-based lithium composite transition metal oxide has no sufficient capacity characteristics and thus a limitation in application in environments requiring high capacity such as rechargeable batteries for next-generation electric vehicles, electric power storage, and the like.

In order to improve this problem, recent studies have been conducted to increase the content of Ni in the NCM-based/NCA-based lithium composite transition metal oxide. However, a high concentration nickel positive electrode active material having a high nickel content has a problem of rapidly deteriorating thermal stability due to deterioration of structural stability and chemical stability of the active material. In addition, as the nickel content in the active material is increased, a residual amount of lithium by-products present in the form of LiOH, Li₂CO₃, and the like on the positive electrode active material surface increases, resulting in gas generation and swelling, which also cause a problem of deteriorating a cycle-life and stability of batteries.

Accordingly, it is required to develop a high concentration Ni (high-Ni) positive electrode active material meeting the high capacity and exhibiting excellent structural and thermal stability, reduced lithium by-products, and improved cycle-life characteristics.

### DISCLOSURE

### Technical Problem

An embodiment provides a positive electrode for a rechargeable lithium battery having excellent lithium ion conductivity as well as preventing a side reaction of a positive electrode active material with an electrolyte by including a polyimide-based polymer having a carboxyl group in a positive electrode, wherein the polyimide-based polymer having high heat resistance and high stability is not phase-decomposed in the positive electrode to form a complex compound but protects the surface of the positive electrode active material.

Another embodiment provides a rechargeable lithium battery including the positive electrode for the rechargeable lithium battery.

### Technical Solution

An embodiment provides a positive electrode for a rechargeable lithium battery including a positive electrode active material, a conductive material, and a binder, wherein the positive electrode includes a polyimide-based polymer having a carboxyl group.

The polyimide-based polymer may be included in 0.1 to 1 part by weight based on 100 parts by weight of the total amount of the mixture of the positive electrode active material, the conductive material, and the binder.

The positive electrode active material may further include a coating layer on the surface and the coating layer may include the polyimide-based polymer.

A thickness of the coating layer may be 1 nm to 50 nm.

The polyimide-based polymer may further include a lithium ion.

The lithium ion may be included in an amount of 0.1 wt % to 1 wt % based on the total weight of the polyimide-based polymer.

An acid value of the polyimide-based polymer including the carboxy group may be 10 to 100 KOH mg/g.

The glass transition temperature (T_{g}) of the polyimide-based polymer may be 160° C. to 280° C.

The positive electrode active material may be at least one of lithium composite oxides represented by Chemical Formula 1.

LiₐM¹_{1-y1-z1}M²_{y1}M³_{z1}O₂ [Chemical Formula 1]

In Chemical Formula 1, 0.9≤a≤1.8, 0≤y1≤1, 0≤z1≤1, 0≤y1+z1<1, and M¹, M², and M³ are each independently selected from a metal of Ni, Co, Mn, Al, Sr, Mg, or La, and a combination thereof.

The positive electrode active material may be a lithium composite oxide represented by Chemical Formula 1-1.

Liₓ₂Ni_{y2}Co_{z2}Al_{1-y2-z2}O₂ [Chemical Formula 1-1]

In Chemical Formula 1-1, 0.9≤x2≤1.2, 0.5≤y2≤1, and 0≤z2≤0.5.

Another embodiment provides a rechargeable lithium battery including the positive electrode, a negative electrode, and an electrolyte.

The negative electrode includes a negative electrode active material, and the negative electrode active material may include a Si-based active material, a carbon-based active material, a lithium metal, or a combination thereof.

### Advantageous Effects

The positive electrode for the rechargeable lithium battery includes the polyimide-based polymer having the carboxyl group, so that a rechargeable lithium battery having improved capacity characteristics and cycle-life characteristics may be implemented.

### DESCRIPTION OF THE DRAWINGS

FIG. 1 is a schematic view illustrating a rechargeable lithium battery according to an embodiment.

FIG. 2 shows the impedance measurement results of rechargeable lithium battery cells of Example 1 and Comparative Examples 1 and 3 in a state of BOL (Beginning Of Life).

FIG. 3 shows the impedance measurement results of the rechargeable lithium battery cells of Example 1 and Comparative Examples 1 and 3 in a state of EOL (End Of Life).

### MODE FOR INVENTION

Hereinafter, specific embodiments will be described in detail so that those of ordinary skill in the art can easily implement them. However, this disclosure may be embodied in many different forms and is not construed as limited to the example embodiments set forth herein.

In the present specification, the terminology used herein is used to describe embodiments only, and is not intended to limit the present invention. The singular expression includes the plural expression unless the context clearly dictates otherwise.

In the present specification, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

Hereinafter, a positive electrode for a rechargeable lithium battery according to an embodiment will be described.

Since the positive electrode has excellent thermal stability, a rechargeable lithium battery with improved cycle-life characteristics may be provided.

Specifically, the positive electrode for a rechargeable lithium battery according to an embodiment includes a positive electrode active material, a conductive material, and a binder, wherein the positive electrode includes a polyimide-based polymer having a carboxyl group.

Conventionally, in order to realize a high-capacity rechargeable lithium battery, there has been an attempt to secure capacity characteristics by increasing an Ni content in NCM-based/NCA-based lithium composite transition metal oxide, but this high concentration nickel positive electrode active material brings about a problem of lowering high-temperature stability of the battery and deteriorating cycle-life characteristics due to swelling and the like, and accordingly, in order to compensate this problem, when a heterogeneous element is doped on the positive electrode active material itself or used as a coating layer, there is a problem of reducing capacity of the positive electrode active material.

In the positive electrode for a rechargeable lithium battery according to an embodiment, a polyimide-based polymer having high heat resistance and high stability is not phase-decomposed in the positive electrode to form a complex compound but protects the surface of the positive electrode active material and thus prevents a side reaction of the positive electrode active material with the electrolyte, resultantly improving cycle-life characteristics of the rechargeable lithium battery under high-temperature and high-voltage conditions. In addition, since the polyimide-based polymer includes a carboxyl group, which increases an interaction between the polyimide-based polymer and the positive electrode active material, the polyimide-based polymer is well coated on the positive electrode active material surface, and in addition, as the polyimide-based polymer includes lithium ions, conductivity of the lithium ions is improved, securing stability of the rechargeable lithium battery including the same.

The polyimide-based polymer may be included in an amount of 0.1 to 1 part by weight, for example 0.1 to 0.8 parts by weight, for example 0.1 to 0.6 parts by weight, for example 0.2 to 0.6 parts by weight, for example 0.2 to 0.5 parts by weight, based on 100 parts by weight of the total amount of the mixture of the positive electrode active material, the conductive material, and the binder. When the content of the polyimide-based polymer satisfies the above range, thermal stability and high-temperature cycle-life characteristics of a rechargeable lithium battery including the polyimide-based polymer may be improved.

In an embodiment, the positive electrode active material may further include a coating layer on a surface, and the coating layer may include the polyimide-based polymer having the carboxyl group. The polyimide-based polymer included in the coating layer may prevent the positive electrode active material from directly contacting with the electrolyte and act as a protective layer blocking attack from HF (hydrogen fluoride) generated from the electrolyte due to a small amount of moisture. In addition, the carboxyl group included in the polyimide-based polymer may promote an interaction such as ionic bonding with a metal included in the positive electrode active material and the like and in addition, prevent a crack of the positive electrode active material as the polyimide-based polymer is uniformly coated on the positive electrode active material surface and also elution of transition metal included in the positive electrode active material. Furthermore, the coating layer provides an electron transfer path to uniformly maintain a current and voltage distribution in the positive electrode, improving cycle-life characteristics of the rechargeable lithium batteries.

The coating layer may have a thickness of 1 nm to 50 nm, for example 1 nm to 40 nm, for example 1 nm to 30 nm, for example 3 nm to 20 nm, or for example 3 nm to 10 nm. When the coating layer has a thickness of less than 1 nm, the coating layer may have an insignificant effect of preventing a side reaction of the positive electrode active material with the electrolyte, but when the coating layer has a thickness of greater than 50 nm, mobility of lithium ions decreases, increasing resistance.

In an embodiment, the polyimide-based polymer may further include a lithium ion. As a result, the polyimide-based polymer distributed in the positive electrode or included in the coating layer of the positive electrode active material may promote the movement of lithium ions and electrons by improving ionic conductivity.

The lithium ion according to the embodiment may be included in an amount of 0.1 to 1 wt %, for example, 0.1 to 0.7 wt %, for example 0.1 to 0.5 wt %, for example 0.1 to 0.3 wt %, based on the total weight of the polyimide-based polymer. When the lithium ion is included in an amount of greater than 1 wt % in the polyimide-based polymer, since the lithium ion is eluted in the electrolyte and thus forms a metal salt reduced from the negative electrode and increases a battery internal resistance, the amount of the lithium ion is appropriately adjusted.

The polyimide-based polymer having the carboxyl group according to an embodiment, considering the content of lithium ion, internal battery resistance, and the like, may have an acid value of 10 (KOH mg/g) to 100 (KOH mg/g), for example 10 (KOH mg/g) to 80 (KOH mg/g), for example 10 (KOH mg/g) to 60 (KOH mg/g), for example 20 (KOH mg/g) to 60 (KOH mg/g), or for example 30 (KOH mg/g) to 50 (KOH mg/g). When the polyimide-based polymer has an acid value within the range, a uniform coating layer is formed on the positive electrode active material, improving ion conductivity of the lithium ion, etc. and resultantly, securing thermal stability and excellent cycle-life characteristics of the batteries.

In an embodiment, the polyimide-based polymer may have a glass transition temperature (T_{g}) of 160° C. to 280° C., for example, 170° C. to 250° C. When the glass transition temperature is within the above range, the solubility of the polyimide-based polymer in a solvent may be adjusted and optimized.

The positive electrode may include a current collector and a positive electrode active material layer including a positive electrode active material formed on the current collector.

The positive electrode may be manufactured by mixing a positive electrode active material, a binder, a conductive material, and the polyimide-based polymer in a solvent to prepare a positive electrode active material slurry, and then coating the positive electrode active material slurry on a current collector followed by drying and pressing. Therefore, in the positive electrode according to an embodiment, the polyimide-based polymer may be uniformly distributed in the positive electrode active material layer.

The positive electrode active material may include lithiated intercalation compounds that reversibly intercalate and deintercalate lithium ions.

Specifically, a composite oxide of a nickel-containing metal and lithium may be used.

Examples of the positive electrode active material may include a compound represented by any one of the following chemical formulas.

LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}Dₐ (0.90≤a≤1.8, 0≤b≤0.5, 0≤c≤0.5, 0≤a≤2); LiₐNi_{1-b-c}Co_{b}X_{c}O₂₋ₐTₐ (0.90≤a≤1.8, 0≤b≤0.5, 0≤c≤0.05, 0≤a≤2); LiₐNi_{1-b-c}Co_{b}X_{c}O₂₋ₐT₂ (0.90≤a≤1.8, 0≤b≤0.5, 0≤c≤0.05, 0≤a≤2); LiₐNi_{1-b-c}Mn_{b}X_{c}Dₐ (0.90≤a≤1.8, 0≤b≤0.5, 0≤c≤0.05, 0≤a≤2); LiₐNi_{1-b-c}Mn_{b}X_{c}O₂₋ₐTₐ (0.90≤a≤1.8, 0≤b≤0.5, 0≤c≤0.05, 0≤a≤2); LiₐNi_{1-b-c}Mn_{b}X_{c}O₂₋ₐT₂ (0.90≤a≤1.8, 0≤b≤0.5, 0≤c≤0.05, 0≤a≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GeO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂ (PO₄)₃ (O≤f≤2); LiₐFePO₄ (0.90≤a≤1.8)

In the chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compound may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed by a method having no adverse influence on properties of a positive electrode active material by using these elements in the compound and for example, the method may include any coating method (e.g., spray coating, dipping, etc.), but is not illustrated in more detail since it is well-known to those skilled in the related field.

The positive electrode active material may be, for example, at least one of lithium composite oxides represented by Chemical Formula 3.

LiₐM¹_{1-y1-z1}M²_{y1}M³_{z1}O₂ [Chemical Formula 3]

In Chemical Formula 3,

0.9≤a≤1.8, 0≤y1≤1, 0≤z1≤1, 0≤y1+z1<1, and M¹, M², and M³ may each independently be selected from a metal of Ni, Co, Mn, Al, Sr, Mg, or La, and a combination thereof.

In an embodiment, M¹ may be Ni, and M² and M³ may each independently be a metal such as Co, Mn, Al, Sr, Mg, or La.

In a specific embodiment, M¹ may be Ni, M² may be Co, and M³ may be Mn or Al, but they are not limited thereto.

In a more specific embodiment, the positive electrode active material may be a lithium composite oxide represented by Formula 3-1.

Liₓ₂Ni_{y2}Co_{z2}Al_{1-y2-z2}O₂

In Chemical Formula 3-1, 0.9≤x2≤1.2, 0.5≤y2≤1, and 0≤z2≤0.5.

A content of the positive electrode active material may be 90 wt % to 98 wt % based on the total weight of the positive electrode active material layer.

In an embodiment, the positive electrode active material layer may include a binder and a conductive material. Herein, the binder and conductive material may be included in an amount of 1 wt % to 5 wt %, respectively based on the total weight of the positive electrode active material layer.

The binder improves binding properties of positive electrode active material particles with one another and with a current collector, and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to provide electrode conductivity and any electrically conductive material may be used as a conductive material unless it causes a chemical change in a battery, and examples thereof may be a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may be Al, but is not limited thereto.

Another embodiment provides a rechargeable lithium battery including the positive electrode according to the embodiment, a negative electrode, and an electrolyte.

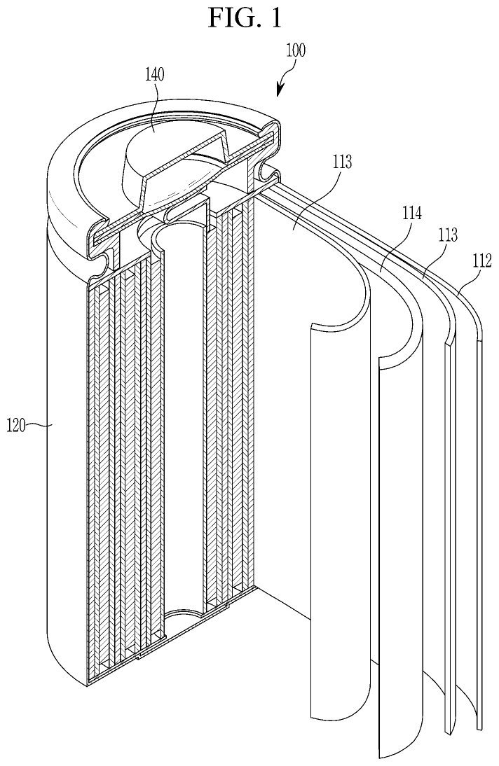

FIG. 1 is a schematic view illustrating a rechargeable lithium battery according to an embodiment. Referring to FIG. 1, a rechargeable lithium battery 100 according to an embodiment of the present invention includes a battery cell including a positive electrode 114, a negative electrode 112 facing the positive electrode 114, a separator 113 between the positive electrode 114 and the negative electrode 112, and an electrolyte (not shown) for a rechargeable lithium battery impregnating the positive electrode 114, negative electrode 112, and separator 113, a battery case 120 housing the battery cell, and a sealing member 140 sealing the battery case 120.

The negative electrode includes a current collector and a negative electrode active material layer formed on the current collector and including a negative electrode active material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may be any carbon-based negative electrode active material commonly used in a lithium ion rechargeable battery and a representative example of the carbon-based negative electrode active material may be crystalline carbon, amorphous carbon, or both. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material, wherein the Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn), and at least one of these materials may be mixed with SiO₂. The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be 10 wt % to 50 wt % based on the total weight of the silicon-carbon composite. In addition, the content of the crystalline carbon may be 10 wt % to 70 wt % based on the total weight of the silicon-carbon composite, and the content of the amorphous carbon may be 20 wt % to 40 wt % based on the total weight of the silicon-carbon composite. In addition, a thickness of the amorphous carbon coating layer may be 5 nm to 100 nm. An average particle diameter (D50) of the silicon particles may be 10 nm to 20 μm. The average particle diameter (D50) of the silicon particles may be preferably 10 nm to 200 nm. The silicon particles may exist in an oxidized form, and in this case, an atomic content ratio of Si:O in the silicon particles indicating a degree of oxidation may be a weight ratio of 99:1 to 33:67. The silicon particles may be SiOₓ particles, and in this case, the range of x in SiOₓ may be greater than 0 and less than 2. In the present specification, unless otherwise defined, an average particle diameter (D50) indicates a particle where a cumulative volume is 50 volume % in a particle distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and used, the mixing ratio may be a weight ratio of 1:99 to 10:90 wt %. The carbon-based negative electrode active material may include crystalline carbon or amorphous carbon. The crystalline carbon may be artificial graphite, natural graphite, or a combination thereof. The amorphous carbon precursor may be coal pitch, mesophase pitch, petroleum pitch, charcoal-based oil, petroleum-based heavy oil, or a polymer resin such as a phenol resin, a furan resin, a polyimide resin, and the like.

A rechargeable lithium battery including a Si-based negative electrode active material or a Sn-based negative electrode active material and an electrolyte that includes the additive including the compound represented by Chemical Formula 1 may exhibit excellent room-temperature and high-temperature cycle life characteristics. In particular, this effect may be more remarkably improved when the content of the additive containing the compound represented by Chemical Formula 1 is included in the above range.

Examples of the transition metal oxide may include vanadium oxide, lithium vanadium oxide, and lithium titanium oxide.

In the negative electrode active material layer, the negative electrode active material may be included in an amount of 95 wt % to 99 wt % based on the total weight of the negative electrode active material layer.

In an embodiment, the negative electrode active material layer further includes a binder, and may optionally further include a conductive material. The content of the binder in the negative electrode active material layer may be 1 wt % to 5 wt % based on the total weight of the negative electrode active material layer. In addition, when the conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber (SBR), an acrylated styrene-butadiene rubber, an acrylonitrile-butadiene rubber (ABR), an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li. The amount of the thickener used may be 0.1 parts by weight to 3 parts by weight based on 100 parts by weight of the negative electrode active material.

The conductive material is included to provide electrode conductivity and any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

The electrolyte includes a non-aqueous organic solvent and a lithium salt.

The non-aqueous organic solvent serves as a medium for transmitting ions taking part in the electrochemical reaction of a battery.

The non-aqueous organic solvent may be a carbonate-based, ester-based, ether-based, ketone-based, or alcohol-based solvent, or aprotic solvent. The carbonate-based solvent includes dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like and the ester-based solvent includes methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may be dibutyl ether, tetraglyme, diglyme, dimethoxyethane, 2-methyltetrahydrofuran, tetrahydrofuran, and the like and the ketone-based solvent may be cyclohexanone, and the like. In addition, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and the like.

The non-aqueous organic solvent may be used alone or in a mixture, and when used in a mixture, the mixing ratio may be appropriately adjusted in accordance with a desired battery performance, which is widely understood by those skilled in the art.

In addition, in the case of the carbonate-based solvent, a mixture of a cyclic carbonate and a chain carbonate may be used. In this case, when the cyclic carbonate and the chain carbonate are mixed in a volume ratio of about 1:1 to about 1:9, the electrolyte may exhibit excellent performance.

The non-aqueous organic solvent of the present invention may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

The aromatic hydrocarbon-based solvent may be an aromatic hydrocarbon-based compound represented by Chemical Formula 3.

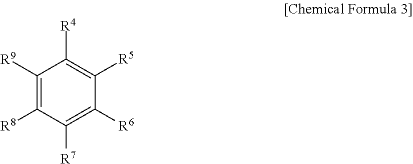

In Chemical Formula 3, R⁴ to R⁹ are the same or different and are selected from hydrogen, a halogen, a C1 to C10 alkyl group, a haloalkyl group, and a combination thereof.

Specific examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate-based compound represented by Chemical Formula 4 in order to improve cycle-life of a battery.

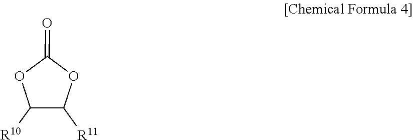

In Chemical Formula 4, R¹⁰ and R¹¹ are the same or different and selected from hydrogen, a halogen, a cyano group (CN), a nitro group (NO₂), and fluorinated C1 to C5 alkyl group, provided that at least one of R¹⁰ and R¹¹ is a halogen, a cyano group (CN), a nitro group (NO₂), and fluorinated C1 to C5 alkyl group, and R¹⁰ and R¹¹ are not simultaneously hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt dissolved in the non-organic solvent supplies lithium ions in a battery, enables a basic operation of a rechargeable lithium battery, and improves transportation of the lithium ions between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide:LiFSI), LiC₄F₉SO₃, LiClO₄, LiAlO₂, LiAlCl₄, LiN(CₓF₂ₓ₊₁SO₂)(C_{y}F_{2y+1}SO₂), wherein x and y are natural numbers, for example, an integer ranging from 1 to 20, LiCl, LiI, and LiB(C₂O₄)₂ (lithium bis(oxalato) borate:LiBOB). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

The separator 113 separates a positive electrode 114 and a negative electrode 112 and provides a transporting passage for lithium ions and may be any generally-used separator in a lithium ion battery. In other words, it may have low resistance to ion transport and excellent impregnation for an electrolyte. For example, separator may be selected from a glass fiber, polyester, Teflon, polyethylene, polypropylene, polytetrafluoroethylene (PTFE), or a combination thereof. It may have a form of a non-woven fabric or a woven fabric. For example, in a lithium ion battery, a polyolefin-based polymer separator such as polyethylene and polypropylene is mainly used. In order to ensure the heat resistance or mechanical strength, a coated separator including a ceramic component or a polymer material may be used. Optionally, it may have a mono-layered or multi-layered structure.

Rechargeable lithium batteries may be classified as lithium ion batteries, lithium ion polymer batteries, and lithium polymer batteries according to the presence of a separator and the kind of electrolyte used therein. The rechargeable lithium batteries may have a variety of shapes and sizes, and include cylindrical, prismatic, coin, or pouch-type batteries, and may be thin film batteries or may be rather bulky in size. Structures and manufacturing methods of these batteries are well known in the art, and thus detailed descriptions thereof will be omitted.

### DETAILED DESCRIPTION OF THE EMBODIMENTS

Hereinafter, examples of the present invention and comparative examples are described. These examples, however, are not in any sense to be interpreted as limiting the scope of the invention.

### Polyimide Polymer Preparation Example 1

Alicyclic dianhydride (4,4′-(hexafluoroisopropylidene)diphthalic anhydride; 6-FDA), is dehydration/condensation-reacted with aromatic diamine containing a carboxyl group and lithium hydroxide, preparing a polyimide polymer, which is dissolved in methylpyrrolidone. The obtained polyimide-based polymer is measured with respect to characteristics in the following method, and the results are shown in Table 1.
Glass transition temperature (Tg): Measured using Perkin Elmer's Pyris 6 DSC.
Acid value: measured according to the ASTM D 974 method.
Viscosity: Measured at 25° C. with a Brookfield rotational viscometer.

TABLE 1

| | Glass transition | Acid value | Viscosity |
|---|---|---|---|
| | temperature (T_{g}) (° C.) | (KOH mg/g) | (cPs/25° C.) |
| Preparation | 240 | 40 | 280 |
| Example 1 | | | |

### Manufacture of Rechargeable Lithium Battery Cell

### Example 1

Li_{1.03}Ni_{0.916}Co_{0.07}Al_{0.014}O₂ as a positive electrode active material, polyvinylidene fluoride (PVDF) as a binder, carbon black as a conductive material, and the polyimide-based polymer prepared by using a polyimide-based polymer having a carboxyl group according to Preparation Example 1 are mixed in a weight ratio of 95.75:2:2:0.25 and dispersed in N-methyl pyrrolidone (NMP), preparing positive electrode active material slurry.

The positive electrode active material slurry is coated at a loading level of 10 mg/cm² on a 15 μm-thick Al foil and then, dried at 120° C. and pressed, manufacturing a positive electrode with electrode density of 3.65 g/cc.

The prepared positive electrode, a 0.7 mm-thick lithium metal, a 25 μm-thick polyethylene separator, and an electrolyte are used, manufacturing a coin-type half rechargeable battery cell (CHC).

The electrolyte had a composition as follows.

(Composition of Electrolyte)

Salt: 1.5 M LiPF₆

Solvent:ethylene carbonate:ethylmethyl carbonate:dimethyl carbonate (EC:EMC:DMC=a volume ratio of 2:1:7)

### Example 2

A rechargeable lithium battery cell is manufactured in the same manner as in Example 1 except that the positive electrode active material, the binder, the conductive material, and the polyimide-based polymer of Preparation Example 1 are mixed in a weight ratio of 95.5:2:2:0.5.

### Comparative Example 1

A rechargeable lithium battery cell is manufactured in the same manner as in Example 1 except that the positive electrode active material, the binder, and the conductive material are mixed in a weight ratio of 96:2:2, but the polyimide-based polymer is not added thereto.

### Comparative Example 2

A rechargeable lithium battery cell is manufactured in the same manner as in Example 1 except that the positive electrode active material, the binder, the conductive material, and the polyimide-based polymer of Preparation Example 1 are mixed in a weight ratio of 95:2:2:1.

### Comparative Example 3

A rechargeable lithium battery cell is manufactured in the same manner as in Example 1 except that the positive electrode active material, the binder, and the conductive material are mixed in a weight ratio of 95.5:2.5:2, but the polyimide-based polymer is not added thereto.

### Experimental Example 1: Evaluation of High-Temperature Characteristics

The rechargeable lithium battery cells according to Examples 1 to 2 and Comparative Examples 1 to 3 are charged to a voltage of 0.01 V at a constant current of 0.2 C and discharged to 1.5 V at a constant current of 0.2 C and then, measured with respect to 50th cycle characteristics after the 1st charge/discharge. The charge and discharge experiment is performed respectively at 25° C. and 45° C. The capacity retention rate is defined by Equation 1.

### Equation 1

Capacity retention rate (%)=(discharge capacity at the 50th cycle/discharge capacity at the 1st cycle)×100

The rechargeable lithium battery cells according to Examples 1 to 2 and Comparative Examples 1 to 3 are measured with respect to capacity retention, and the results are shown in Table 2.

TABLE 2

| | Capacity retention | Capacity retention |
|---|---|---|
| | rate (%, 50th | rate (%, 50th |
| | cycle, 25° C.) | cycle, 45° C.) |
| Example 1 | 95.4 | 92.4 |
| Example 2 | 95.1 | 91.8 |
| Comparative Example 1 | 95.0 | 90.3 |
| Comparative Example 2 | 94.6 | 91.7 |
| Comparative Example 3 | 93.3 | 89.5 |

As shown in Table 2, the rechargeable lithium battery cells of Examples 1 to 2 according to an embodiment exhibit excellent high-temperature cycle-life characteristics, compared with the rechargeable lithium battery cells of Comparative Examples 1 to 3.

### Experimental Example 2: Evaluation of Resistance Characteristics

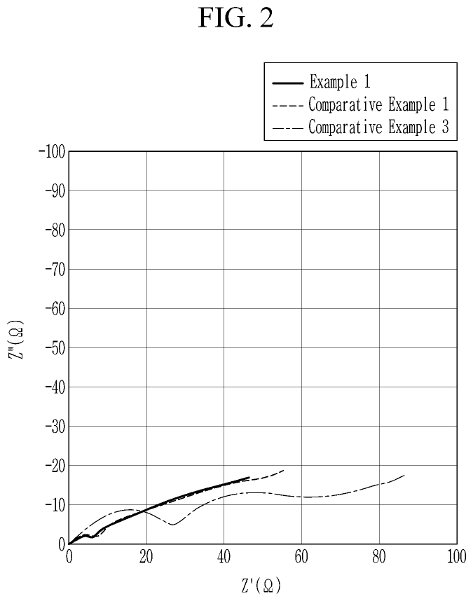

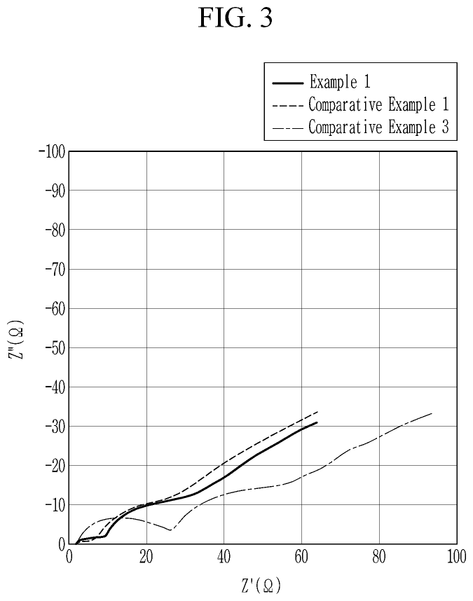

The rechargeable lithium battery cells of Example 1 and Comparative Example 3 are evaluated with respect to resistance characteristics. Each resistance is measured by using EIS (Electrochemical Impedance Spectroscopy). Specifically, Example 1 and Comparative Example 3 are measured with respect to resistance in a state of BOL (Beginning Of Life) and EOL (End Of Life) under conditions of frequency of 300000 to 0.1 Hz and Ac amplitude of 10 mA by Solartron Analytical EIS (Solartron Analytical Ametek), and the results are shown in FIGS. 2 and 3.

As shown in FIGS. 2 and 3, the rechargeable lithium battery cell according to Example 1 exhibits equivalent resistance characteristics to the rechargeable lithium battery cell including no polyimide-based polymer in a positive electrode according to Comparative Example 1.

Hereinbefore, the example embodiments of the present disclosure have been described and illustrated, however, it is apparent to a person with ordinary skill in the art that the present invention is not limited to the exemplary embodiment as described, and may be variously modified and transformed without departing from the spirit and scope of the present invention. Accordingly, the modified or transformed exemplary embodiments as such may not be understood separately from the technical ideas and aspects of the present invention, and the modified exemplary embodiments are within the scope of the claims of the present invention.

[Description of Symbols]

| | | | |
|---|---|---|---|
| 100: | rechargeable lithium battery | 112: | negative electrode |
| 113: | separator | 114: | positive electrode |
| 120: | battery case | 140: | sealing member |

1. A positive electrode for a rechargeable lithium battery, comprising
a positive electrode active material, a conductive material, and a binder,
wherein the positive electrode includes a polyimide-based polymer having a carboxyl group.

2. The positive electrode for the rechargeable lithium battery of claim 1, wherein
the polyimide-based polymer having the carboxyl group is included in 0.1 to 1 part by weight based on 100 parts by weight of the total amount of the mixture of the positive electrode active material, the conductive material, and the binder.

3. The positive electrode for the rechargeable lithium battery of claim 1, wherein
the positive electrode active material further includes a coating layer on the surface, and
the coating layer includes the polyimide-based polymer.

4. The positive electrode for the rechargeable lithium battery of claim 3, wherein
a thickness of the coating layer is 1 nm to 50 nm.

5. The positive electrode for the rechargeable lithium battery of claim 1, wherein
the polyimide-based polymer having the carboxyl group further includes a lithium ion.

6. The positive electrode for the rechargeable lithium battery of claim 5, wherein
the lithium ion is included in an amount of 0.1 wt % to 1 wt % based on the total weight of the polyimide-based polymer having the carboxyl group.

7. The positive electrode for the rechargeable lithium battery of claim 1, wherein
an acid value of the polyimide-based polymer having the carboxyl group is 10 to 100 KOH mg/g.

8. The positive electrode for the rechargeable lithium battery of claim 1, wherein
a glass transition temperature (T_{g}) of the polyimide-based polymer is 160° C. to 280° C.

9. The positive electrode for the rechargeable lithium battery of claim 1, wherein
the positive electrode active material is at least one of lithium composite oxides represented by Chemical Formula 1:
LiₐM¹_{1-y1-z1}M²_{y1}M³_{z1}O₂ [Chemical Formula 1]
wherein, in Chemical Formula 1,
0.9≤a≤1.8, 0≤y1≤1, 0≤z1≤1, 0≤y1+z1<1, and M¹, M², and M³ are each independently selected from a metal of Ni, Co, Mn, Al, Sr, Mg, or La, and a combination thereof.

10. The positive electrode for the rechargeable lithium battery of claim 1, wherein
the positive electrode active material is a lithium composite oxide represented by Chemical Formula 1-1:
Liₓ₂Ni_{y2}Co_{z2}Al_{1-y2-z2}O₂ [Chemical Formula 1-1]
wherein, in Chemical Formula 1-1,
0.9≤x2≤1.2, 0.5≤y2≤1, and 0≤z2≤0.5.

11. A rechargeable lithium battery, comprising
the positive electrode of claim 1;
a negative electrode; and
an electrolyte.

12. The rechargeable lithium battery of claim 11, wherein
the negative electrode includes a negative electrode active material, and
the negative electrode active material includes a Si-based active material, a carbon-based active material, a lithium metal, or a combination thereof.
